(19) United States
(12) Patent Application Publication
(10) Pub. No.: US 2006/0101325 A1
(43) Pub. Date: May 11, 2006

(54) Liquid crystal display device and driving method of the same

(75) Inventors: Nobuo Sasaki, Kawasaki (JP); Susumu Okazaki, Kawasaki (JP); Yasuhiro Nasu, Kawasaki (JP); Yoji Nagase, Kawasaki (JP)

Correspondence Address: GREER, BURNS & CRAIN, 300 S WACKER DR, 25TH FLOOR, CHICAGO, IL, 60606, US

(73) Assignees: FUJITSU LIMITED; FUJITSU DISPLAY TECHNOLOGIES CORPORATION

(21) Appl. No.: 11/086,809

(22) Filed: Mar. 22, 2005

Related U.S. Application Data
(63) Continuation of application No. PCT/JP03/11629, filed on Sep. 11, 2003.

(30) Foreign Application Priority Data
Mar. 31, 2003 (JP) 2003-094197

(51) Int. Cl. G06F 17/00

(52) U.S. Cl. 715/503; 715/509

(57) ABSTRACT

The invention relates to an active matrix type liquid crystal display device and its driving method and provides a liquid crystal display device capable of omitting frame memory in image averaging processing among pixels for improving the smoothness of display and its driving method. For example, by providing an accumulated-charge-averaging TFT circuit which executes averaging of accumulated charges of a sub-pixel among a plurality of sub-pixels constructed within a pixel and adjacent sub-pixels within pixels adjacent thereto, thereby realizing smoothing processing of the display image without using a frame memory.

### BACKGROUND OF THE INVENTION

1. Field of the Invention

The present invention relates to an active matrix type liquid crystal display device (hereinafter abbreviated as “LCD”) and its driving method.

2. Description of the Related Art

In an active matrix type LCD, as a switching element in every pixel electrode formed in a pixel, for example, a thin film transistor (hereinafter abbreviated as “TFT”) is provided. The pixel electrode is connected to one data bus line via a pixel TFT. When a gate pulse of a predetermined voltage is applied to a predetermined gate bus line, the pixel TFT becomes in an ON state, and a predetermined gray-scale voltage having been fed into the data bus line is applied to the pixel electrode; and when the pixel TFT becomes in an OFF state, the gray-scale voltage is held. In this way, a liquid crystal molecule is held in the predetermined inclined state by a liquid crystal capacitance formed by a pixel electrode and an opposite electrode and a liquid crystal layer interposed therebetween, and a desired photo transmittance based on this inclined state is held, thereby executing image display. Thus, one pixel is driven by one gate bus line and one data bus line.

Now, when a gray-scale abruptly changes among pixels, the image quality loses smoothness, whereby the image display may become unnatural. In order to prevent such a phenomenon from occurring, it may be considered to increase the number of the pixels. However, since it is necessary to increase the display data in proportion to the increase of the number of pixels, the problem cannot be overcome by merely increasing the number of pixels of LCD.

As a method of solving the problem by improving the LCD only, there is an image processing method in which gray-scale voltages written in respective pixels are averaged among the adjacent pixels, thereby displaying a smooth image. However, the image processing method requires a frame memory for temporarily storing a written data of each pixel.

Non-Patent Document 1

Nobuo Sasaki, Akihito Hara, Fumiyo Takeuchi, Katsuyuki Suga, Michiko Takei, Ken-ichi Yoshino, and Mitsuru Chida, “CW Lateral Kesshoka (CLC) Gijutsu Ni Yoru Idodo 500 cm²/Vs Wo Koeru Shin Teion Pori Si-TFT Gijutsu” (New Low-Temperature Poly-Si-TFT Technologies Exceeding 500 cm²/Vs of Mobility by CW Lateral Crystallization (CLC) Technology), Denshi Joho Tsushin Gakkai Rombunshi C, Vol. J85-C, No. 8, pp. 601-608 (2002).

Non-Patent Document 2

A. Hara, F. Takeuchi, and N. Sasaki, “Selective Singlecrystalline-silicon Growth at the Pre-Defined Active Regions of TFTs on a Glass by a Scanning CW Laser Irradiation”, IEEE IEDM '00 Tech. Digest, p. 209 (2000).

Non-Patent Document 3

A. Hara, Y. Mishima, T. Kakehi, F. Takeuchi, M. Takei, K. Yoshino, K. Suga, M. Chida, and N. Sasaki, “High performance poly-Si TFTs on a glass by a stable scanning CW laser lateral crystallization”, IEEE IEDM '01 Tech. Digest, p. 747 (2001).

Non-Patent Document 4

Y. Sano, M. Takei, A. Hara, and N. Sasaki, “High-performance single-crystalline-silicon TETs on a non-alkali glass substrate”, IEEE IEDM '03, Tech. Digest.

Non-Patent Document 5

K. Yoshino, M. Takei, M. Chida, A. Hara, and N. Sasaki, “Effect on poly-Si film uniformity and TFT performance of overlap irradiation by a stable scanning CW laser”, Proc. 9^{th} Int. Display Workshops '02 (Hiroshima, Dec. 4-6, 2002), pp. 343-346 (2002).

### SUMMARY OF THE INVENTION

An object of the invention is to provide a liquid crystal display device capable of omitting frame memory in image averaging processing among pixels for improving the smoothness of display and its driving method.

The object of the invention as described above is achieved by a driving method of a liquid crystal display device characterized in that it applies a predetermined gray-scale voltage respectively to a plurality of sub-pixels constructing a pixel and averaging accumulated charge among the adjacent sub-pixels of the adjacent pixels.

The driving method of a liquid crystal display device of the present invention is characterized in that the averaging processing is carried out after charging a plurality of sub-pixels in the same pixel to the same accumulated potential.

The driving method of a liquid crystal display device of the present invention is characterized in that the pixel and the adjacent pixel are the same color of any one of red (R), green (G) and blue (B).

The object as described above is achieved by a liquid crystal display device characterized in that it contains a plurality of sub-pixels constructing a pixel and an accumulated-charge-averaging TFT which executes averaging of accumulated charge among the adjacent sub-pixels of the adjacent pixels.

The liquid crystal display device of the present invention is characterized in that it contains a pixel TFT for applying a gray-scale voltage to the sub-pixels and a gate bus line to which a gate electrode of the accumulated-charge-averaging TFT and a gate electrode of the pixel TFT are commonly connected.

The liquid crystal display device of the present invention is characterized in that it contains a pixel TFT for applying a gray-scale voltage to the sub-pixels, a gate bus line for pixel TFT to which a gate electrode of the pixel TFT is connected, and a gate bus line for averaging accumulated charge to which a gate electrode of the accumulated-charge-averaging TFT is connected.

The liquid crystal display device of the present invention is characterized in that the pixel TFT and the accumulated-charge-averaging TFT are different from each other in the conductive type of channel.

The liquid crystal display device of the present invention is characterized in that the accumulated-charge-averaging TFT connects adjacent sub-pixels having the same color of any one of red (R), green (G) and blue (B) to each other.

The liquid crystal display device of the present invention is characterized in that at least one of the pixel TFT and the accumulated-charge-averaging TFT has a channel region formed by the CW lateral crystallization technology.

### BRIEF DESCRIPTION OF THE DRAWINGS

FIG. 1 is a view showing a schematic construction of a liquid crystal display device according to an embodiment of the present invention and its driving method, in which four monochromic pixels P11, P12, P21 and P22 arranged in the matrix state of 2 lines×2 rows among a group of a plurality of pixels having been formed in the matrix state within an LCD display region are chosen and seen in the normal direction of the display faces thereof;

FIG. 2 is a view showing a concrete circuit for realizing a driving method of a liquid crystal display device according to an embodiment of the present invention, in which two sub-pixels Sa and Sb are formed within each of four monochromic pixels P11, P12, P13 and P14 aligned by 1 row×4 columns;

FIG. 3 is a view showing a schematic construction of a liquid crystal display device 1 having a peripheral driving circuit according to example 1 of an embodiment of the invention formed integrally on an array substrate 2;

FIG. 4 is a view showing a concrete circuit for realizing a driving method of a liquid crystal display device 1 according to example 1 of an embodiment of the present invention, in which four sub-pixels Sa, Sb, Sc and Sd are formed within each of four pixels P22, P23, P32 and P33 aligned by 2 rows×2 columns;

FIG. 5 is a view showing a concrete circuit for realizing a driving method of a liquid crystal display device according to example 2 of an embodiment of the present invention;

FIG. 6 is a view showing a concrete circuit for realizing a driving method of a liquid crystal display device according to example 3 of an embodiment of the present invention;

FIG. 7 is a view showing a concrete circuit for realizing a driving method of a liquid crystal display device according to example 4 of an embodiment of the present invention;

FIG. 8 is a view showing a concrete circuit for realizing a driving method of a liquid crystal display device according to example 4 of an embodiment of the present invention, which shows an equivalent circuit of green pixels P22G and P32G and blue pixels P22B and P32B in addition to an equivalent circuit of red pixels P22R, P23R, P32R and P33R of FIG. 7; and

FIG. 9 is a view showing one example of a pattern layout of a pixel circuit of a red pixel P22R according to example 4 of an embodiment of the present invention.

### DESCRIPTION OF THE PREFERRED EMBODIMENTS

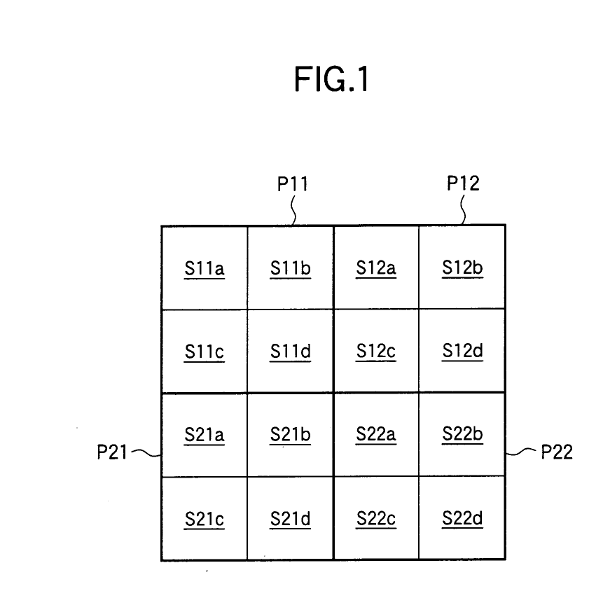

A liquid crystal display device and its driving method according to an embodiment of the present invention will be hereunder described with reference to FIGS. 1 to 9. The embodiment is characterized in that it provides a TFT circuit for averaging accumulated charge, which executes averaging of accumulated charges of a plurality of sub-pixels constructed within one pixel and adjacent sub-pixels within pixels adjacent thereto, thereby realizing smoothing processing of the display image without using a frame memory. In recent years, the present inventors developed a novel formation method of a poly-silicon (p-Si) thin film using a CW (continuous wave oscillation) lateral crystallization technology. In the CW lateral crystallization technology, an amorphous Si (a-Si) layer is converted into a p-Si layer upon irradiation with continuous oscillation laser beams injected from CW solid laser. Since the continuous oscillation laser beams are lowered with respect to a laser beam power as compared with pulse oscillation laser beams of the excimer laser crystallization method, the width of a region where the a-Si can be melted is narrow, but conversely, a region where polycrystallization is not necessary is not irradiated with laser beams. Accordingly, according to the CW lateral crystallization technology, it is possible to increase throughput of polycrystallization by omitting laser irradiation of the a-Si layer of a region where TFT is not formed.

By forming a channel region using the CW lateral crystallization technology, it is possible to form, on a large-sized glass substrate, TFT capable of realizing a mobility (400 to 600 cm²/Vs) comparable to MOS transistors of single crystalline Si having an overwhelmingly high mobility in comparison with a mobility (100 to 300 cm²/Vs) obtained by a conventional p-Si thin film or a mobility (0.8 cm²/Vs) obtained by conventional a-Si. Thus, since TFT formed using the CW lateral crystallization technology has a high mobility, even when the TFT size is made small, it is possible to secure sufficient driving ability. For this reason, it is possible to prepare a highly functional TFT circuit for averaging accumulated charge while minimizing an influence against the aperture within such a small area as a pixel of LCD.

Next, the schemaic construction of the driving method of a liquid crystal display device according to the embodiment will be described with reference to FIG. 1. FIG. 1 shows a view, in which four monochromic pixels P11, P12, P21 and P22 arranged in the matrix shape of 2 rows×2 columns among a group of a plurality of pixels having been formed in the matrix shape within an LCD display region are chosen and seen in the normal direction of the display faces thereof. The inside of the pixel P11 is constructed of four sub-pixels S11a, S11b, S11c and S11d arranged in the matrix shape of 2 rows×2 columns. Pixel electrodes formed in the respective sub-pixels S11a, S11b, S11c and S11d are formed independently of each other. In the remaining pixels P12, P21 and P22, sub-pixels having the same construction are also formed.

The pixel driving method of the embodiment will be described using the construction of the pixels and sub-pixels as illustrated in FIG. 1. First of all, as the first stage, by turning on a pixel TFT (not shown), predetermined gray-scale voltages V11, V12, V21 and V22 are respectively applied to pixel electrodes within the respective pixels P11, P12, P21 and P22 from a data bus line (not shown). At this stage, the same voltage as the gray-scale voltage V11 is applied to each of the sub-pixels S11a, S11b, S11c and S11d within the pixel P11. The same voltages as the gray-scale voltages V12, V21 and V22 are applied also to the respective sub-pixels within the pixels P12, P21 and P22. That is, the following relations can be set up.
V11=V11a=V11b=V11c=V11d
V12=V12a=V12b=V12c=V12d
V21=V21a=V21b=V21c=V21d
V22=V22a=V22b=V22c=V22d

Next, as the second stage, by turning off the pixel TFT, the respective pixels P11, P12, P21 and P22 are electrically separated from the data bus line. Next, by turning on a accumulated-charge-averaging TFT (not shown), the four sub-pixels S11d, S12c, S21b and S22a adjacent to each other in the center among the sub-pixels of the respective pixels P11, P12, P21 and P22 are made in a conducting state to each other. Thus, the respective sub-pixels S11d, S12c, S21b and S22a have an average voltage of voltages applied in the original four pixels P11, P12, P21 and P22. That is, the following relation can be set up.
V11d=V12c=V21b=V22a=(V11+V12+V21+V22)/4

According to the driving method, even when a gray-scale abruptly changes among the four monochromic pixels P11, P12, P21 and P22 arranged in the matrix shape of 2 rows×2 columns, such an abrupt change is relieved, whereby a smooth image display can be obtained.

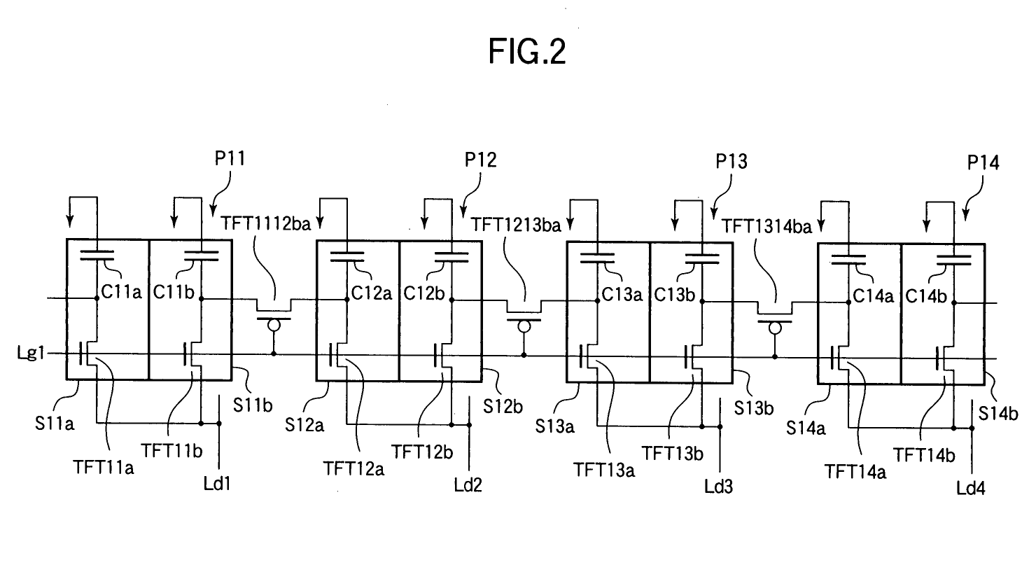

Next, a concrete circuit for realizing the driving method of a liquid crystal display device according to the embodiment will be described with reference to FIG. 2. For the sake of simplifying the explanation, in FIG. 2, the case where four monochromic pixels P11, P12, P13 and P14 are arranged by 1 row×4 columns, and two sub-pixels are formed in each of the pixels P11, P12, P13 and P14 will be explained.

The pixel P11 has two sub-pixels S11a and S11b. Pixel electrodes formed in the respective sub-pixels S11a and S11b are formed independently of each other. In the pixel electrode of the sub-pixel S11a, for example, a source electrode of a pixel TFT11a of n-chFET is connected. A drain electrode of the pixel TFT11a is connected to a data bus line Ld1, and a gate electrode is connected to a gate bus line Lg1. A liquid crystal capacitance C11a is formed by the pixel electrode of the sub-pixel S11a and the opposite electrode and a liquid crystal layer (not shown) interposed therebetween.

In the pixel electrode of the sub-pixel S11b, for example, a source electrode of a pixel TFT11b is connected. A drain electrode of the pixel TFT11b of n-chFET is connected to the data bus line Ld1, and a gate electrode is connected to the gate bus line Lg1. A liquid crystal capacitance C11b is formed by the pixel electrode of the sub-pixel S11b and the opposite electrode and a liquid crystal layer (not shown) interposed therebetween. The sub-pixel S11b is adjacent to a sub-pixel S12a of the pixel P12.

The pixel P12 has two sub-pixels S12a and S12b. Pixel electrodes formed in the respective sub-pixels S12a and S12b are formed independently of each other. In the pixel electrode of the sub-pixel S12a, for example, a source electrode of a pixel TFT12a of n-chFET is connected. A drain electrode of the pixel TFT12a is connected to a data bus line Ld2, and a gate electrode is connected to the gate bus line Lg1. A liquid crystal capacitance C12a is formed by the pixel electrode of the sub-pixel S12a and the opposite electrode and a liquid crystal layer (not shown) interposed therebetween.

In the pixel electrode of the sub-pixel S12b, for example, a source electrode of a pixel TFT12b is connected. A drain electrode of the pixel TFT12b of n-chFET is connected to the data bus line Ld2, and a gate electrode is connected to the gate bus line Lg1. A liquid crystal capacitance C12b is formed by the pixel electrode of the sub-pixel S12b and the opposite electrode and a liquid crystal layer (not shown) interposed therebetween. The sub-pixel S12a is adjacent to the sub-pixel S11b of the adjacent pixel P11. The sub-pixel S12b is adjacent to a sub-pixel S13a of the adjacent pixel P13.

In the LCD, an accumulated-charge-averaging TFT1112ba which connects the pixel electrode of the sub-pixel S11b to the pixel electrode of the sub-pixel S12a is formed. The accumulated-charge-averaging TFT1112ba is a p-chFET, and its gate electrode is connected to the gate bus line Lg1, and its source and drain electrodes are connected to the pixel electrode of the sub-pixel S11b and the pixel electrode of the sub-pixel S12a, respectively.

The pixel P13 has sub-pixels S13a and S13b which are independent of each other, and the pixel P14 also has sub-pixels S14a and S14b which are independent of each other. Concrete circuit constructions of the pixels P13 and P14 are the same as that of the pixel P11. Also, an accumulated-charge-averaging TFT1213ba which connects the pixel electrode of the sub-pixel S12b to the pixel electrode of the sub-pixel S13a is formed. The accumulated-charge-averaging TFT1213ba is a p-chFET, its gate electrode is connected to the gate bus line Lg1, and its source and drain electrodes are connected to the pixel electrode of the sub-pixel S12b and the pixel electrode of the sub-pixel S13a, respectively.

Also, an charge-averaging TFT1314ba which connects the pixel electrode of the sub-pixel S13b to the pixel electrode of the sub-pixel S14a is formed. The accumulated-charge-averaging TFT1314ba is a p-chFET, its gate electrode is connected to the gate bus line Lg1, and its source and drain electrodes are connected to the pixel electrode of the sub-pixel S13b and the pixel electrode of the sub-pixel S14a, respectively.

Next, in the pixels P11, P12, P13 and P14, the driving method according to the embodiment will be described. First of all, for the purpose of writing a predetermined gray-scale data in each of the pixels P11, P12, P13 and P14, a gate pulse of a positive voltage is applied to the gate bus line Lg1. Since pixel TFT11a, TFT11b, TFT12a, TFT12b, TFT13a, TFT13b, TFT14a and TFT14b are n-chFET, they are in an ON state only when the gate pulse of a positive voltage is applied. On the other hand, since accumulated-charge-averaging TFT1112ba, TFT1213ba and TFT1314ba are p-chFET, they hold the OFF state. Thus, a gray-scale voltage V11 having been applied to the data bus line Ld1 is applied to the pixel electrodes of the sub-pixels S11a and S11b via the pixel TFT11a and TFT11b. Similarly, a gray-scale voltage V12 having been applied to the data bus line Ld2 is applied to the pixel electrodes of the sub-pixels S12a and S12b via the pixel TFT12a and TFT12b; a gray-scale voltage V13 having been applied to a data bus line Ld3 is applied to the pixel electrodes of the sub-pixels S13a and S13b via the pixel TFT13a and TFT13b; and a gray-scale voltage V14 having been applied to a data bus line Ld4 is applied to the pixel electrodes of the sub-pixels S14a and S14b via the pixel TFT14a and TFT14b.

In the liquid crystal layers of the sub-pixels S11a and S11b, an electric field based on a potential difference between the predetermined gray-scale voltage V11 applied to the pixel electrode of each of the sub-pixels S11a and S11b and a voltage in the opposite electrode side is applied, and a charge based on the gray-scale voltage V11 is held in the liquid crystal capacitances C11a and C11b. Similarly, a charge based on the gray-scale voltage V12 is held in the liquid crystal capacitances C12a and C12b of the sub-pixels S12a and S12b; a charge based on the gray-scale voltage V13 is held in the liquid crystal capacitances C13a and C13b of the sub-pixels S13a and S13b; and a charge based on the gray-scale voltage V14 is held in the liquid crystal capacitances C14a and C14b of the sub-pixels S14a and S14b.

Next, a gate pulse of a negative voltage is applied to the gate bus line Lg1. Since accumulated-charge-averaging TFT1112ba, TFT1213ba and TFT1314ba are p-chFET, they are in an ON state only when the gate pulse of a negative voltage is applied. On the other hand, since the pixel TFT11a, TFT11b, TFT12a, TFT12b, TFT13a, TFT13b, TFT14a and TFT14b are an n-chFET, they hold the OFF state.

Thus, the pixel electrode of the sub pixel S11b and the pixel electrode of the sub-pixel S12a become in a conducting state via the accumulated-charge-averaging TFT1112ba, and the charge is re-distributed between the sub-pixels S11b and S12a, thereby executing averaging processing of the pixel potential. Accordingly, the pixel electrode of the sub-pixel S11b and the pixel electrode of the sub-pixel S12a have the same potential.

That is, the following relation can be set up.
V11b=V12a=(V11+V12)/2

Similarly, the pixel electrode of the sub-pixel S12b and the pixel electrode of the sub-pixel S13a become in the conducting state via the accumulated-charge-averaging TFT1213ba, and the charge is re-distributed between the sub-pixels S12b and S13a, thereby executing averaging processing of the pixel potential. Also, the pixel electrode of the sub-pixel S13b and the pixel electrode of the sub-pixel S14a become in the conducting state via the accumulated-charge-averaging TFT1314ba, and the charge is re-distributed between the sub-pixels S13b and S14a, thereby executing averaging processing of the pixel potential.

Accordingly, the pixel electrode of the sub-pixel S12b and the pixel electrode of the sub-pixel S13a have the same potential, and the pixel electrode of the sub-pixel S13b and the pixel electrode of the sub-pixel S14a have the same potential.

That is, the following relations can be set up.
V12b=V13a=(V12+V13)/2
V13b=V14a=(V13+V14)/2

According to the driving method of the embodiment, even when a gray-scale abruptly changes between the monochromic pixels P11 and P12, between the monochromic pixels P12 and P13 and between the monochromic pixels P13 and P14, respectively, such an abrupt change is relieved, whereby a smooth image display can be obtained.

For example, by controlling the capacitance values of the liquid crystal capacitances C11b and C12a, it is possible to subject the averaging processing of the pixel potential to weighting. For example, by adjusting the volume ratio of the liquid crystal capacitance C11b to the liquid crystal capacitance C12a at 1 to 2, it is possible to make the ratio of the voltage to be applied to the pixel electrode of the sub-pixel S11b to the pixel electrode of the sub-pixel S12a at 2 to 1.

Next, an ON condition and an OFF condition of the n-chFETs of the pixel TFT11a, TFT11b, TFT12a, TFT12b, TFT13a, TFT13b, TFT14a and TFT14b and the p-chFETs of accumulated-charge-averaging TFT1112ba, TFT1213ba and TFT1314ba will be described. Let us assume that the voltage to be applied to each of the liquid crystal capacitances C11a, C11b, C12a, C12b, C13a, C13b, C14a and C14b are in the range of from −5V (negative voltage) to +5V (positive voltage) while the potential of the opposite electrode is made 0V. The n-chFET becomes in an ON state whereas the p-chFET holds an OFF state on the condition:
Vg>Vthn+5 (Expression 1)
wherein Vg represents a gate pulse voltage to be applied to the gate bus line Lg1, and Vthn represents a threshold voltage of the n-chFET.

On the other hand, the p-chFET becomes in an ON state whereas the n-chFET holds an OFF state on the condition:
Vg<Vthp−5 (Expression 2)
wherein Vg represents a gate pulse voltage to be applied to the gate bus line Lg1, and Vthp represents a threshold voltage.

Further, when a voltage margin ΔV is taken into consideration for the sake of surely executing the action while taking into consideration a scattering of the threshold voltage and a sub-threshold leakage current, the condition (expression 1) on which the n-chFET becomes in an ON state whereas the p-chFET becomes in an OFF state is:
Vg>Vthn+5+ΔV (Expression 3)

On the other hand, the condition (expression 2) where the p-chFET becomes in an ON state, whereas the n-chFET becomes in an OFF state is:
Vg<Vthp−5ΔV (Expression 4)

In the case where the averaging function of the pixel potential according to the embodiment is not employed, a gate pulse which satisfies the following condition may be applied to the gate bus line Lg1. That is, in the writing action into the pixels P11, P12, P13 and P14, for the purpose of holding the p-chFET in an OFF state with the n-chFET being in an ON state, the following condition may be employed.
Vg>Vthn+5 (Expression 1)

On the other hand, for the purpose of holding the p-chFET in an ON state with the n-chFET being in an OFF state, the voltage level Vg of the gate bus line Lg1 may be made as follows.
Vthn+5>Vg>Vthp−5 (Expression 5)

While an example in which the pixel TFT11a and the like are formed of n-chFET, and the accumulated-charge-averaging TFT1112ba and the like are formed of a p-chFET has been described, as a matter of course, the pixel TFT11a and the like may be formed of a p-chFET, and the accumulated-charge-averaging TFT1112ba and the like may be formed of an n-chFET.

The method in which the embodiment is applied to a matrix type LCD will be h described more specifically with reference to the following examples.

### EXAMPLE 1

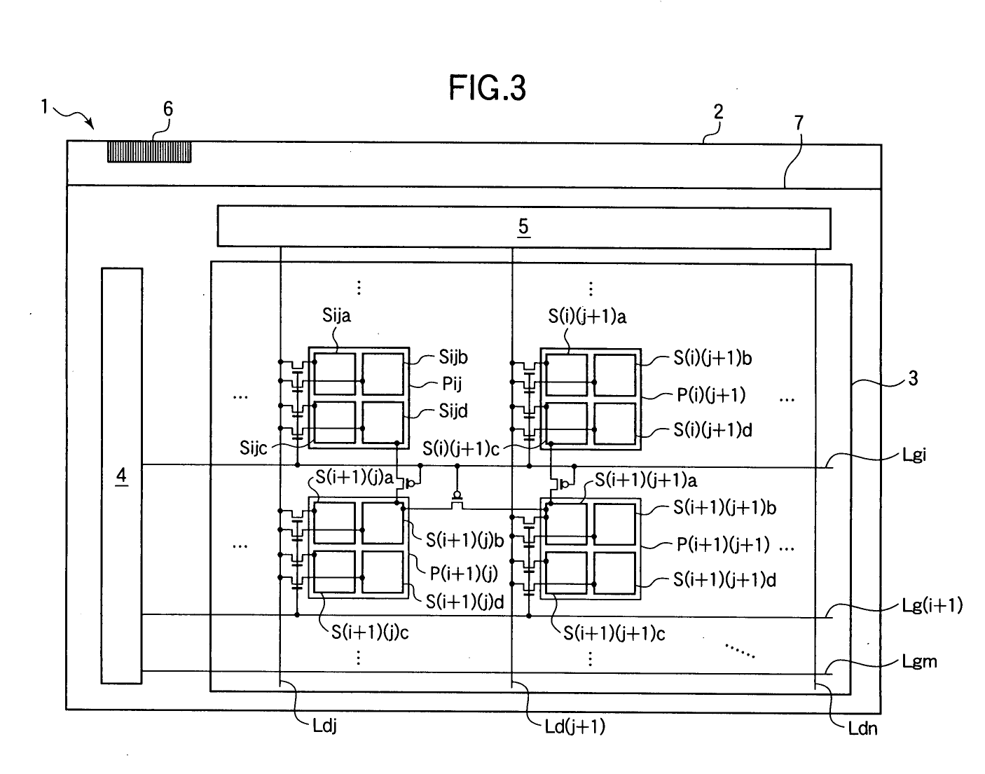

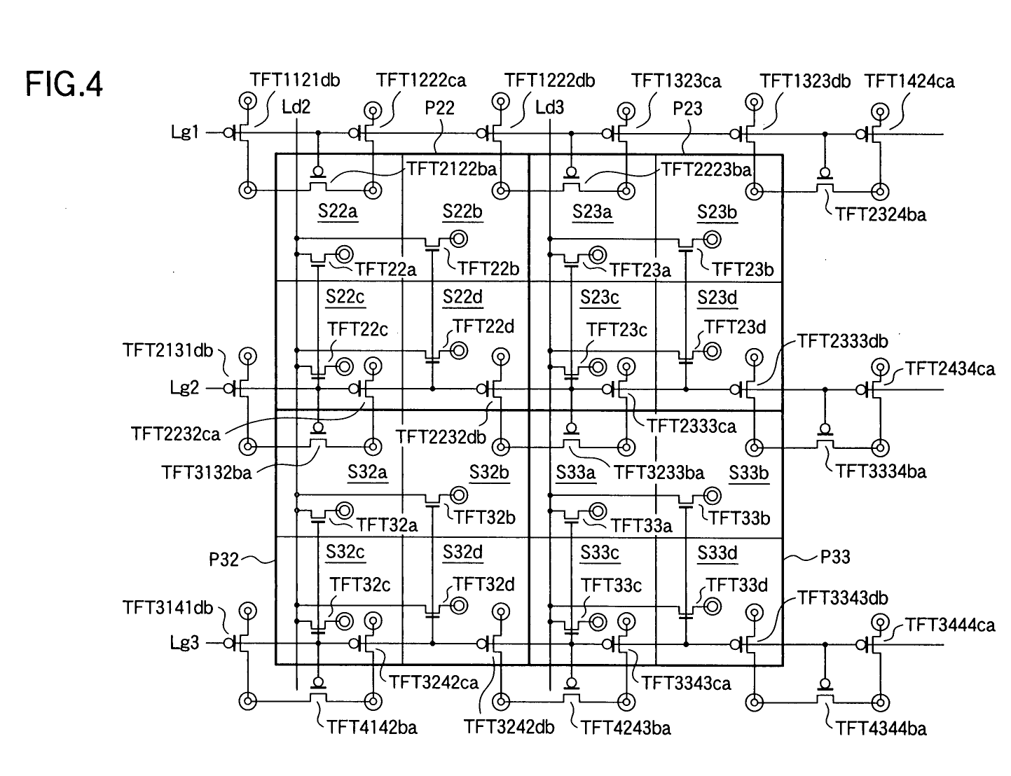

A concrete circuit for realizing a driving method of a liquid crystal display device according to example 1 of the embodiment will be described with reference to FIGS. 3 and 4. FIG. 3 shows a schematic construction of a liquid crystal display device 1 having a peripheral driving circuit formed integrally on an array substrate 2. On the array substrate 2, a display region 3 in which a number of pixels having a pixel TFT and a pixel electrode (both not shown) are arranged in the matrix shape is fixed. In the surrounding of the display region 3, a gate driver 4 and a data driver 5, each of which is one constructive element of a peripheral driving circuit formed by a low-temperature poly-silicon manufacturing process, are arranged. The gate driver 4 is formed in the left portion of the drawing, and the data driver 5 is formed in the upper portion of the drawing. Also, an input terminal 6 from which a dot clock, a digital gray-scale data and the like are inputted from the side of a system (not shown) is provided in the upper portion of the drawing within the array substrate 2. The array substrate 2 is stuck together with an opposite substrate 7 facing opposite to each other via a sealing material (not shown). A liquid crystal (not shown) is sealed in a cell gap between the array substrate 2 and the opposite substrate 7.

In the display region 3, a gate bus line Lg extending in the horizontal direction in the drawing is formed in the number of m in parallel with the vertical direction in the drawing. Also, a data bus line Ld extending in the direction substantially perpendicular to the gate bus line Lg is formed via a insulating film (not shown) in the number of n in the horizontal direction in the drawing.

A pixel Pij is arranged in a crossing portion between a gate bus line Lgi and a data bus line Ldj. In FIG. 3, among a plurality of pixels arranged in the matrix shape of m rows×n columns, adjacent four pixels of 2 rows×2 columns, Pij, P(i)(j+1), P(i+1)(j) and P(i+1)(j+1) are illustrated. The pixel Pij is arranged in the crossing portion between the gate bus line Lgi and the data bus line Ldj. The pixel Pij is divided into four sub-pixels Sija, Sijb, Sijc and Sijd formed independently of each other. Each of the sub-pixels Sija, Sijb, Sijc and Sijd is connected to the data bus line Ldj via a pixel TFT. Also, a gate electrode of the pixel TFT is connected to the gate bus line Lgi. The pixels P(i)(j+1), P(i+1)(j) and P(i+1)(j+1) have the same construction as the pixel Pij. The pixel P(i)(j+1) is connected to a data bus line Ld(j+1) via a predetermined pixel TFT having a gate electrode connected to the gate bus line Lgi, and the pixel P(i+1)(j) is connected to a data bus line Ldj via a presecribed pixel TFT having a gate electrode connected to a gate bus line Lg(i+1). Also, the pixel P(i+1)(j+1) is connected to a data bus line Ld(j+1) via a predetermined pixel TFT having a gate electrode connected to the gate bus line Lg(i+1).

Further, the sub-pixels Sija, Sijb, Sijc and Sijd of the respective pixel Pij are connected to any one of adjacent sub-pixels Sxyα of sub-pixels Sxya, Sxyb, Sxyc and Sxyd of adjacent sub-pixel Pxy via an accumulated-charge-averaging TFT which executes averaging of accumulated charge. For example, a sub-pixel Sijd and a sub-pixel S(i+1)(j)b, a sub-pixel S(i+1)(j)b and a sub-pixel S(i+1)(j+1)a, and a sub-pixel S(i)(j+1)c and a sub-pixel S(i+1)(j+1)a are respectively connected to each other via a predetermined accumulated-charge-averaging TFT.

Gate bus lines Lg1 to Lgm in the number of m are connected to the gate driver 4 formed in the left portion of the drawing of the display region 3. The gate driver 4 successively applies a pulse of a predetermined voltage to the gate bus lines Lg1 to Lgm. Also, data bus lines Ld1 to Ldn in the number of n are connected to the data driver 5 formed in the upper portion of the drawing of the display region 3. The data driver 5 converts a digital gray-scale data inputted from the side of a system (not shown) into an analog gray-scale data (gray-scale voltage) and feeds it to the data bus lines Ld1 to Ldn.

Though the respective pixel Pij is divided into four sub-pixels Sija, Sijb, Sijc and Sijd comparing with a conventional pixel, the number of the gate bus lines Lg1 to Lgm and the number of the data bus lines Ld1 to Ldn for driving the respective pixel Pij do not increase, and one gate bus line Lg1 and one data bus line Ldj are each corresponding to one pixel.

Incidentally, it is possible to drive the gate bus lines Lg1 to Lgm and the data bus lines Ld1 to Ldn by replacing the gate driver 4 and the data driver 5 by arranging a plurality of gate driver ICs (integrated circuit) and data driver ICs having the same functions in the periphery of the array substrate 2.

Next, the driving method of the four pixels Pij, P(i) (j+1), P(i+1)(j) and P(i+1)(j+1) of 2 rows×2 columns as illustrated in FIG. 3 will be described with reference to FIG. 4. In FIG. 4, the case of i=j=2, that is, pixels P22, P23, P32 and P33, is taken as an example, and for the sake of making the explanation simple, the case where pixels P22, P23, P32 and P33 are monochromic pixels is described.

A pixel P22 has four sub-pixels S22a, S22b, S22c and S22d. For example, a source electrode of a pixel TFT22a of n-chFET is connected to a pixel electrode of the sub-pixel S22a. A drain electrode of the pixel TFT22a is connected to a data bus line Ld2, and a gate electrode is connected to a gate bus line Lg2. A liquid crystal capacitance (not shown) is formed by the pixel electrode of the sub-pixel S22a and the opposite electrode and a liquid crystal layer (not shown) interposed therebetween.

A pixel TFT22b of n-chFET is connected to a pixel electrode of the sub-pixel S22b in the same construction. A drain electrode of the pixel TFT22b is connected to the data bus line Ld2, and a gate electrode is connected to the gate bus line Lg2. The sub-pixel S22b is adjacent to a sub-pixel S23a of the pixel P23.

Also, a pixel TFT22c of n-chFET is connected to a pixel electrode of the sub-pixel S22c in the same construction. A drain electrode of the pixel TFT22c is connected to the data bus line Ld2, and a gate electrode is connected to the gate bus line Lg2. The sub-pixel S22c is adjacent to a sub-pixel S32a of the pixel P32.

Similarly, a pixel TFT22d of n-chFET is connected to a pixel electrode of the sub-pixel S22d. A drain electrode of the pixel TFT22d is connected to the data bus line Ld2, and a gate electrode is connected to the gate bus line Lg2. The sub-pixel S22d is adjacent to a sub-pixel S23c of the pixel P23 and a sub-pixel S32b of the pixel P32.

Though detailed description is omitted, all of the pixels P23, P32 and P33 have the same circuit construction as the pixel P22; a sub-pixel S23d is adjacent to a sub-pixel S33b; and a sub-pixel S32d is adjacent to a sub-pixel S33c.

Also, in the LCD of the example, an accumulated-charge-averaging TFT2232 db which is connected to a pixel electrode of the sub-pixel S22d and a pixel electrode of the sub-pixel S32b; an accumulated-charge-averaging TFT3233ba which is connected to a pixel electrode of the sub-pixel S32b and a pixel electrode of the sub-pixel S33a; and an accumulated-charge-averaging TFT2333ca which is connected to a pixel electrode of the sub-pixel S23c and a pixel electrode of the sub-pixel S33a are formed. Similarly, a TFT circuit for averaging accumulated charge, which executes averaging of accumulated charges among a plurality of sub-pixels S constructed within the pixel P and adjacent sub-pixels within pixels adjacent thereto is provided in all of the pixels.

Next, the driving method according to the embodiment of this example in the pixels P22, P23, P32 and P33 will be described by taking an example of the four sub-pixels S22d, S23c, S32b and S33a adjacent to each other in the center among the sub-pixels of the respective pixels P22, P23, P32 and P33. First of all, for the purpose of writing a predetermined gray-scale data in each of the pixels P22 and P23, a gate pulse of a positive voltage expressed by the expression 1 is applied to the gate bus line Lg2. At this time, a voltage falling within the voltage range expressed by the expression 5 is applied to the gate bus line Lgi other than the gate bus line Lg2 such that all of the pixel TFTs and the accumulated-charge-averaging TFTs connected to the gate bus line Lgi other than the gate bus line Lg2 hold the OFF state. Incidentally, a gray-scale voltage falling within the range of from −5V to +5V is applied to the respective data bus line Ldj with the potential of the opposite electrode being 0V.

Since the pixels TFT22a, TFT22b, TFT22c, TFT22d, TFT23a, TFT23b, TFT23c and TFT23d connected to the gate bus line Lg2 are n-chFET, they become in an ON state only when a gate pulse of a positive voltage is applied. On the other hand, since the accumulated-charge-averaging TFT2232 db, TFT3233ba and TFT2333ca connected to the gate bus line Lg2 are a p-chFET, they hold the OFF state. Thus, a gray-scale voltage V22 having been applied to the data bus line Ld2 is applied to the pixel electrodes of the sub-pixels S22a, S22b, S22c and S22d via the pixel TFT22a, TFT22b, TFT22c and TFT22d. Similarly, a gray-scale voltage V23 having been applied to a data bus line Ld3 is applied to the pixel electrodes of the sub-pixels S23a, S23b, S23c and S23d via the pixel TFT23a, TFT23b, TFT23c and TFT23d.

In liquid crystal layers of the sub-pixels S22a, S22b, S22c and S22d, an electric field based on a potential difference between the predetermined gray-scale voltage V22 applied to the pixel electrodes of the respective sub-pixels S22a, S22b, S22c and S22d and the voltage in the opposite electrode sideis applied, and a charge based on the gray-scale voltage V22 is held in a liquid crystal capacitance (not shown). Similarly, a charge based on the gray-scale voltage V23 is held in liquid crystal capacitances (not shown) of the sub-pixels S23a, S23b, S23c and S23d. When the period of writing a gray-scale data of the pixels P22 and P23 has been completed, a voltage falling within the voltage range expressed by the expression 5 is applied to the gate electrode of the gate bus line Lg2, whereby the gray-scale data writing action in the pixels P22 and P23 is completed.

Next, for the purpose of writing a predetermined gray-scale data in each of the pixels P32 and P33, a gate pulse of a positive voltage expressed by the expression 1 is applied to a gate bus line Lg3. At this time, a voltage falling within the voltage range expressed by the expression 5 is applied to the gate bus line Lgi other than the gate bus line Lg3 such that all of the pixel TFTs and the accumulated-charge-averaging TFTs connected to the gate bus line Lgi other than the gate line Lg3 hold the OFF state.

For the purpose of writing a predetermined gray-scale data in each of the pixels P32 and P33, a gate pulse of a positive voltage expressed by the expression 1 is applied to the gate bus line Lg3; a charge based on a gray-scale voltage V32 is held in liquid crystal capacitances (not shown) of liquid crystal layers of sub-pixels S32a, S32b, S32c and S32d; and a charge based in a gray-scale voltage V33 is held in liquid crystal capacitances (not shown) of liquid crystal layers of sub-pixels S33a, S33b, S33c and S33d. When the period of writing a gray-scale data of the pixels P32 and P33 has been completed, a voltage falling within the voltage range expressed by the expression 5 is applied to the gate electrode of the gate bus line Lg3, whereby the gray-scale data writing action in the pixels P32 and P33 is completed.

Next, averaging processing of the potentials of the sub-pixels S22d, S23c, S32b and S33a is executed. A gate pulse of a negative voltage expressed by the expression 2 is applied to the gate bus line Lg2. Since the accumulated-charge-averaging TFT2232 db, TFT3233ba and TFT2333ca are a p-chFET, they are in the ON state only when a gate pulse of a negative voltage is applied. On the other hand, since the pixel TFT22a, TFT22b, TFT22c, TFT22d, TFT23a, TFT23b, TFT23c and TFT23d are an n-chFET, they hold the OFF state.

Thus, the respective pixel electrodes of the sub-pixels S22d, S23c, S32b and S33a become in the conductive state via the accumulated-charge-averaging TFT2232 db, TFT3233ba and TFT2333ca, and a charge is re-distributed among the sub-pixels S22d, S23c, S32b and S33a, whereby averaging processing of the pixel potentials is executed. Accordingly, the respective pixel electrodes of the sub-pixels S22d, S23c, S32b and S33a become the same potential.

That is, the following relation can be set up.
V22d=V23c=V32b=V33a=(V22+V23+V32+V33)/4

According the driving method of the embodiment, even when a gray-scale abruptly changes between the monochromic pixels P22 and P23, between the monochromic pixels P22 and P32, between the monochromic pixels P22 and P33, between the monochromic pixels P23 and P32, between the monochromic pixels P23 and P33 and between the monochromic pixels P32 and P33, respectively, such an abrupt change is relieved, whereby a smooth image display can be obtained. In this way, according to the example, it is possible to realize smoothing of the pixel display by utilizing a storage function of LCD itself without using an external frame memory.

### EXAMPLE 2

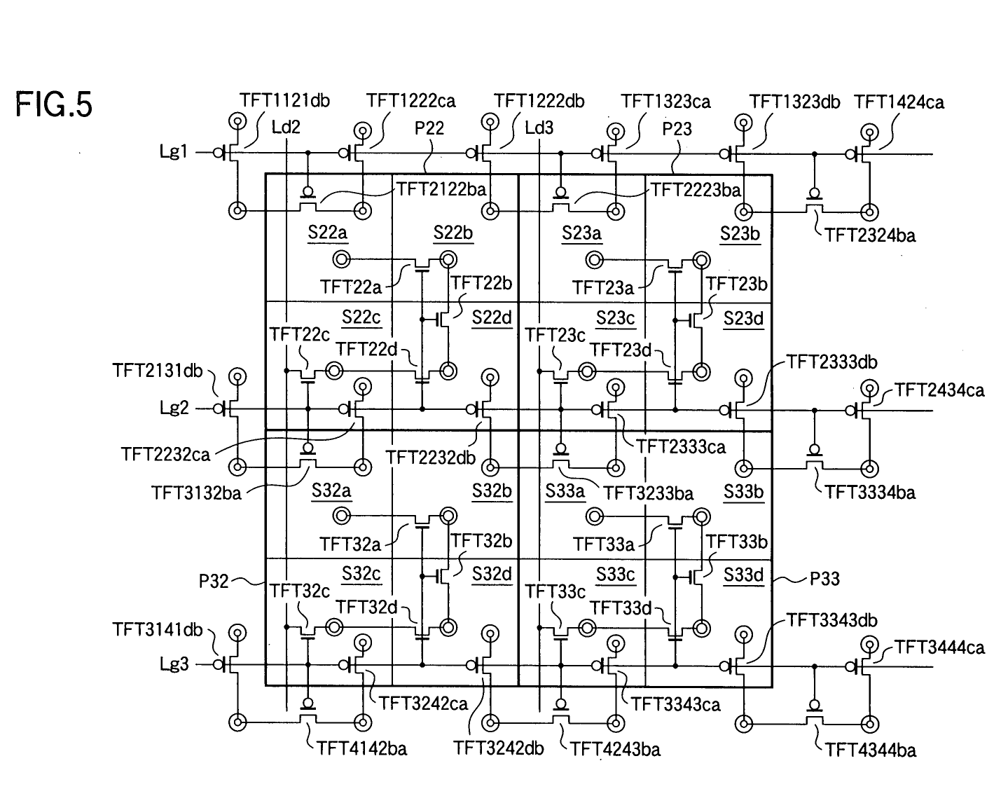

Next, a concrete circuit for realizing a driving method of a liquid crystal display device according to example 2 of the embodiment will be described with reference to FIG. 5. In example 1, four pixel TFTija to TFTijd are connected in parallel to the data bus line Ldj in every pixel. However, as illustrated in FIG. 5, the example is characterized in that pixel TFTija to TFTijd are connected in series, thereby making the number of pixel TFT to be directly connected to the data bus line Ldj one and reducing a load of the data bus line Ldj.

According to the example, not only it is possible to realize smoothing of the pixel display by utilizing a storage function of LCD itself without using an external frame memory, but also it is possible to reduce a load of the data bus line Ld. Accordingly, it is possible to lower driving ability of a data driver (not shown) capable of generating a gray-scale data and outputting it to the data bus line Ldj, thereby realizing low power consumption.

### EXAMPLE 3

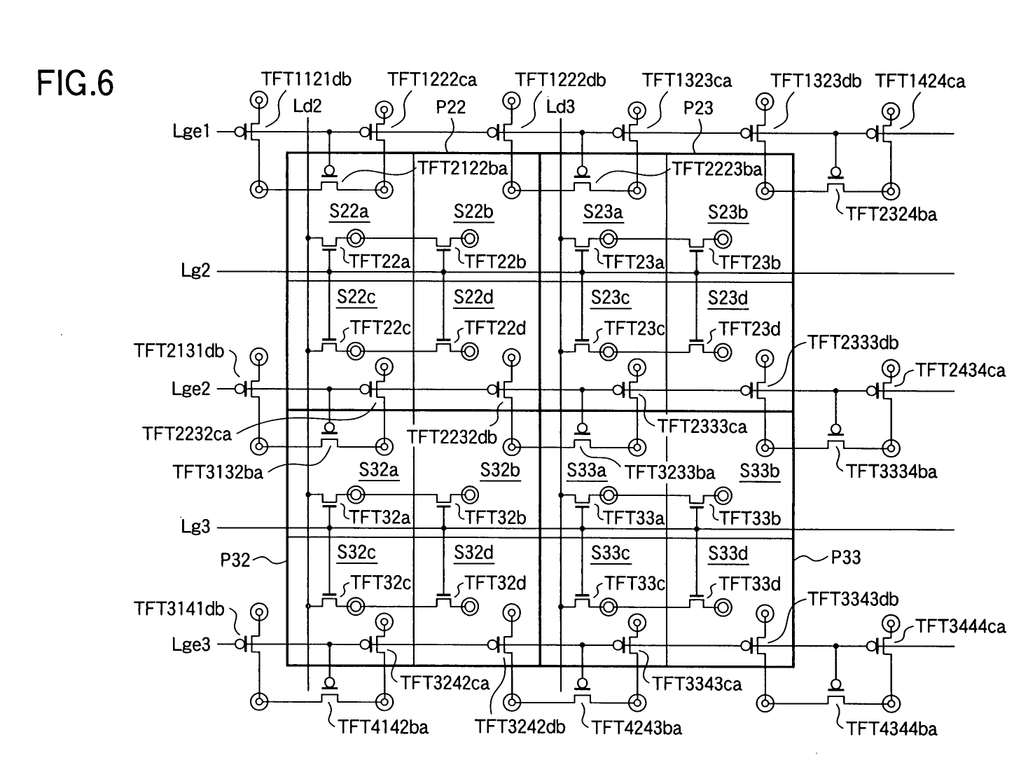

Next, a concrete circuit for realizing a driving method of a liquid crystal display device according to example 3 of the embodiment will be described with reference to FIG. 6. In example 1, not only four pixel TFTija to TFTijd are connected to the data bus line Ldj in every pixel Pij, but also four pixel TFTija to TFTijd and two accumulated-charge-averaging TFTs (for example, TFT(i)(j)(i+1)(j)ca and TFT(i)(j)(i+1)(j)db) are commonly connected to one gate bus line Lgi in every pixel Pij. On the other hand, as illustrated in FIG. 6, four pixel TFTija to TFTijd are divided into two pairs of two members thereof (for example, a pair of TFTija and TFTijb and a pair of TFTijc and TFTijd), and the respective pairs are connected in series to the data bus line Ldj. This example is characterized in that the number of pixel TFT to be directly connected to the data bus line Ldj is lowered into two, thereby reducing a load of the data bus line Ld.

Also, this example is characterized in that a gate bus line Lgi for pixel TFT and a gate bus line Lgei for accumulated-charge-averaging TFT are provided separately, thereby reducing a load of the gate bus line Lg.

According to the example, not only it is possible to realize smoothing of the pixel display by utilizing a storage function of LCD itself without using an external frame memory, but also it is possible to reduce a load of the data bus line Ld and the gate bus line Lg. Accordingly, it is possible to lower driving ability of a data driver (not shown) generating a gray-scale data and outputting it to the data bus line Ldj, thereby realizing low power consumption. Also, since the respective gate bus line Lgi can be driven at two voltage levels, it is possible to make a circuit construction of a gate driver (not shown) driving the gate bus line Lg simple. Also, in this example, since the a gate bus line Lgi for pixel TFT and the gate bus line Lgei for accumulated-charge-averaging TFT are provided separately, it is possible to provide the same conduction type of channel of the pixel TFT and the accumulated-charge-averaging TFT.

### EXAMPLE 4

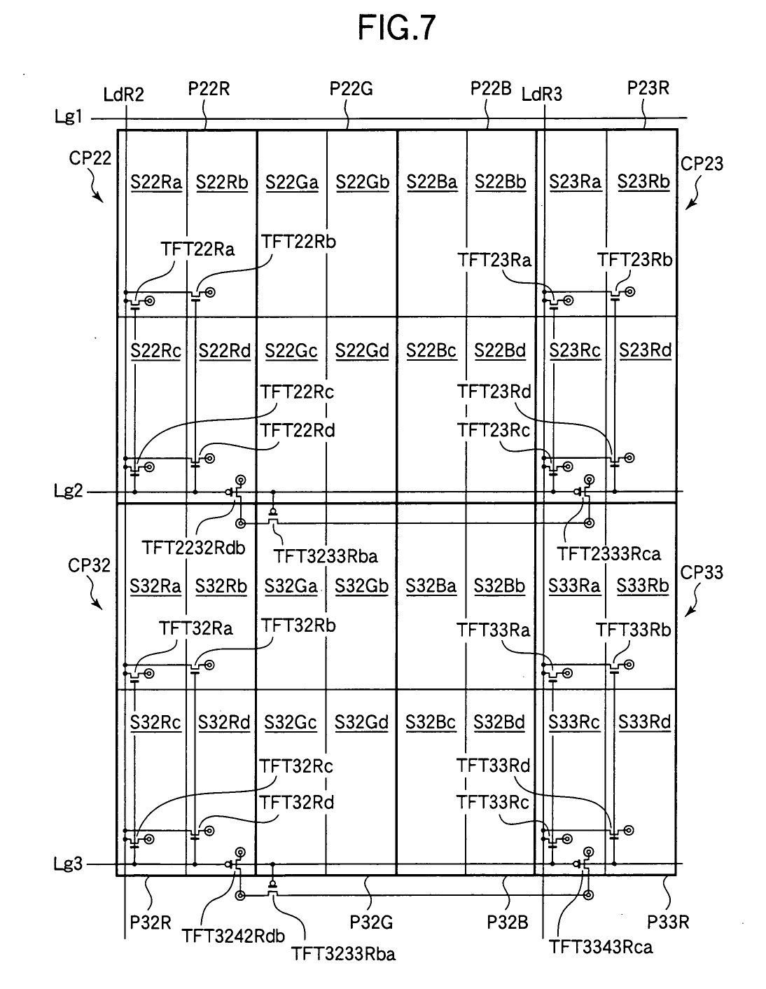

Next, a concrete circuit for realizing a driving method of a liquid crystal display device according to example 4 of the embodiment will be described with reference to FIG. 7. In examples 1 to 3, the examples of monochromic pixels have been described. However, in this example, averaging processing of accumulated-charge of the case of a color LCD having respective pixels red (R), green (G) and blue (B) will be described. FIG. 7 shows a view in which four color pixels CP22, CP23, CP32 and CP33 arranged in the matrix shape of 2 rows×2 columns among a group of a plurality of pixels having been formed in the matrix shape within a color LCD display region are chosen and seen in the normal direction of the display faces thereof. In the color pixel CP22, a red pixel P22R, a green pixel P22G and a blue pixel P22B are arranged in this order from the left side in the drawing. The inside of the red pixel P22R is constructed of four sub-pixels S22Ra, S22Rb, S22Rc and S22Rd arranged in the matrix shape of 2 rows×2 columns. Pixel electrodes formed in the respective sub-pixels S22Ra, S22Rb, S22Rc and S22Rd are formed independently of each other. In the green pixel P22G and the blue pixel P22B, sub-pixels of the same construction are formed. Also, in the remaining color pixels CP23, CP32 and CP33, respective pixels of R, G and B of the same construction are formed.

In the construction of color pixels and sub-pixels as illustrated in FIG. 7, the pixel driving method of the foregoing embodiment can be employed. In this case, the driving method of the embodiment is applied in every same color. When the red pixels P22R, P23R, P32R and P33R as illustrated in FIG. 7 are taken as an example, first of all, for the purpose of writing a predetermined gray-scale data in each of the red pixels P22R and P23R, a gate pulse of a positive voltage expressed by the expression 1 is applied to the gate bus line Lg2. At this time, a voltage falling within the voltage range expressed by the expression 5 is applied to the gate bus line Lgi other than the gate bus line Lg2 such that all of the pixel TFTs and the accumulated-charge-averaging TFTs connected to the gate bus line Lgi other than the gate line Lg2 hold the OFF state. However, a gray-scale voltage is adjusted so as to fall within the range of from −5V to +5V with the potential of the opposite electrode being 0V.

Since the pixel TFT22Ra, TFT22Rb, TFT22Rc, TFT22Rd, TFT23Ra, TFT23Rb, TFT23Rc and TFT23Rd connected to the gate bus line Lg2 are n-chFET, they become in an ON state only when a gate pulse of a positive voltage is applied. On the other hand, since the accumulated-charge-averaging TFT2232Rdb, TFT3233Rba and TFT2333Rca connected to the gate bus line Lg2 are p-chFET, they hold the OFF state. Thus, a gray-scale voltage V22 having been applied to the data bus line LdR2 is applied to the pixel electrodes of the sub-pixels S22Ra, S22Rb, S22Rc and S22Rd via the pixel TFT22Ra, TFT22Rb, TFT22Rc and TFT22Rd. Similarly, a gray-scale voltage V23 having been applied to a data bus line LdR3 is applied to the pixel electrodes of the sub-pixels S23Ra, S23Rb, S23Rc and S23Rd via the pixel TFT23Ra, TFT23Rb, TFT23Rc and TFT23Rd.

In liquid crystal layers of the sub-pixels S22Ra, S22Rb, S22Rc and S22Rd, an electric field based on a potential difference between the predetermined gray-scale voltage V22 applied to the pixel electrodes of the respective sub-pixels S22Ra, S22Rb, S22Rc and S22Rd and the voltage in the opposite electrode side, and a charge based on the gray-scale voltage V22 is held in a liquid crystal capacitance (not shown). Similarly, a charge based on the gray-scale voltage V23 is held in liquid crystal capacitances (not shown) of the sub-pixels S23Ra, S23Rb, S23Rc and S23Rd. When the period of writing a gray-scale data of the red pixels P22R and P23R has been completed, a voltage falling within the voltage range expressed by the expression 5 is applied to the gate electrode of the gate bus line Lg2, whereby the gray-scale data writing action in the red pixels P22R and P23R is completed.

Next, for the purpose of writing a predetermined gray-scale data in each of the red pixels P32R and P33R, a gate pulse of a positive voltage expressed by the expression 1 is applied to a gate bus line Lg3. At this time, a voltage falling within the voltage range expressed by the expression 5 is applied to the gate bus line Lgi other than the gate bus line Lg3 such that all of the pixel TFTs and the accumulated-charge-averaging TFTs connected to the gate bus line Lgi other than the gate line Lg3 hold the OFF state.

For the purpose of writing a predetermined gray-scale data in each of the red pixels P32R and P33R, when a gate pulse of a positive voltage expressed by the expression 1 is applied to the gate bus line Lg3, the pixel TFT32Ra, TFT32Rb, TFT32Rc, TET32Rd, TFT33Ra, TFT33Rb, TFT33Rc and TFT33Rd become in an ON state. Thus, a charge based on a gray-scale voltage V32 is held in liquid crystal capacitances (not shown) of liquid crystal layers of sub-pixels S32Ra, S32Rb, S32Rc and S32Rd; and a charge based on a gray-scale voltage V33 is held in liquid crystal capacitances (not shown) of liquid crystal layers of sub-pixels S33Ra, S33Rb, S33Rc and S33Rd. When the period of writing a gray-scale data of the red pixels P32R and P33R has been completed, a voltage falling within the voltage range expressed by the expression 5 is applied to the gate electrode of the gate bus line Lg3, whereby the gray-scale data writing action in the red pixels P32R and P33R is completed.

Next, averaging processing of the potentials of the sub-pixels S22Rd, S23Rc, S32Rb and S33Ra is executed. A gate pulse of a negative voltage expressed by the expression 2 is applied to the gate bus line Lg2. Since the accumulated-charge-averaging TFT2232Rdb, TFT3233Rba and TFT2333Rca are p-chFET, they are in the ON state only when a gate pulse of a negative voltage is applied. On the other hand, since the pixel TFT22Ra, TFT22Rb, TFT22Rc, TFT22Rd, TFT23Ra, TFT23Rb, TFT23Rc and TFT23Rd are n-chFET, they hold the OFF state.

Thus, the respective pixel electrodes of the sub-pixels S22Rd, S23Rc, S32Rb and S33Ra become in a conductive state via the accumulated-charge-averaging TFT2232Rdb, TFT3233Rba and TFT2333Rca, and a charge is re-distributed among the sub-pixels S22Rd, S23Rc, S32Rb and S33Ra, whereby averaging processing of the pixel potentials is executed. Accordingly, the respective pixel electrodes of the sub-pixels S22Rd, S23Rc, S32Rb and S33Ra have the same potential.

That is, the following relation can be set up.
V22Rd=V23Rc=V32Rb=V33Ra=(V22+V23+V32+V33)/4

With respect to the remaining green pixels P22G, P23G, P32G and P33G and blue pixels P22B, P23B, P32B and P33B, by executing the same drive, even when a gray-scale abruptly changes between the color pixels CP22 and CP23, between the color pixels CP22 and CP32, between the color pixels CP22 and CP33, between the color pixels CP23 and CP32, between the color pixels CP23 and CP33 and between the color pixels CP32 and CP33, respectively, such an abrupt change is relieved, whereby a smooth image display can be obtained.

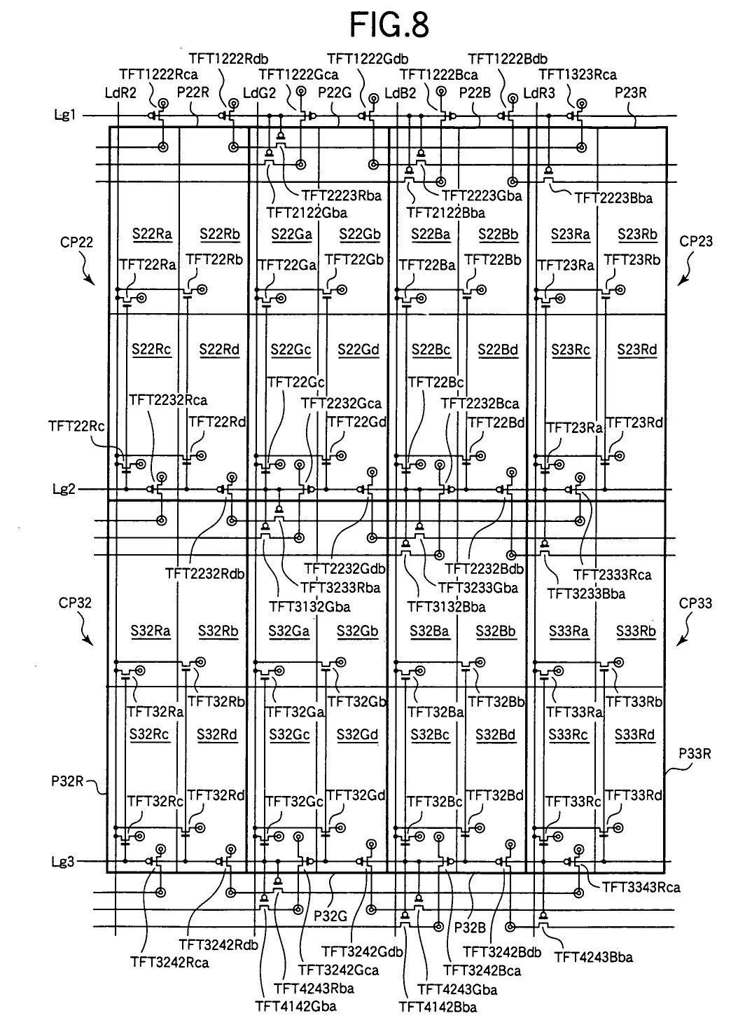

FIG. 8 shows an equivalent circuit of green pixels P22G and P32G and blue pixels P22B and P32B in addition to an equivalent circuit of red pixels P22R, P23R, P32R and P33R as illustrated in FIG. 7.

Though the respective pixel PijX (wherein X represents any one of R, G and B) is divided into four sub-pixels SijXa to SijXd comparing with a conventional pixel, the number of the gate bus lines Lg1 to Lgm and the number of the data bus lines Ld1 to Ldn of each color for driving the respective pixel PijX does not increase, and one gate bus line Lgi and one data bus line Ldj are each corresponding to one pixel.

Thus, since the liquid crystal display device of the example can drive one color pixel CP by one gate bus line and three data bus lines, the number of gate bus line and the number of data bus line do not increase as compared with a conventional liquid crystal display device using color pixels.

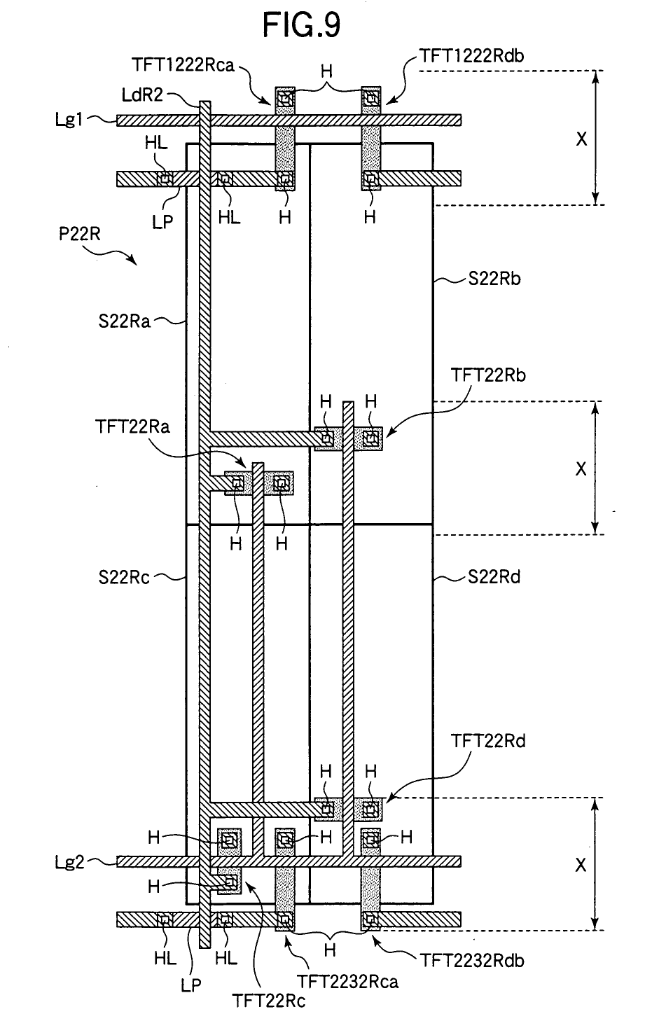

Next, the method of manufacturing of LCD according to the example will be described with reference to FIG. 9. FIG. 9 shows an example of a pattern layout of a pixel circuit of the red pixel P22R as illustrated in FIG. 8. Incidentally, in FIG. 9, the same constructive elements as those shown in FIG. 8 are given the same symbols.

First of all, a silicon oxide film (not shown) is formed on a glass substrate (not shown) using a plasma CVD process. Next, an a-Si layer (not shown) is deposited on the entire surface. Next, irradiation with laser beams is executed using the CW lateral crystallization method, thereby polycrystallizing the a-Si layer in a predetermined region (regions X) illustrated in FIG. 9 into a p-Si layer.

After polycrystallizing the a-Si layer in the predetermined regions to form a p-Si layers, the p-Si layer is subjected to patterning and resultant islanding, thereby forming pixel TFT22Ra, TFT22Rb, TFT22Rc and TFT22Rd and channel region and source and drain regions of accumulated-charge-averaging TFT1222Rca, TFT1222Rdb, TFT2232Rca and TFT2232Rdb as illustrated in FIG. 9. Next, silicon oxide film is formed by the plasma CVD process, thereby forming a gate insulating film. Next, a gate forming metal layer is formed by the sputtering process and then subjected to patterning, thereby forming a gate bus line Lgi (Lg1 and Lg2 are shown in FIG. 9) also working as a gate electrode. Also, a wiring pattern LP is formed in a crossing portion between a connecting wiring of the accumulated-charge-averaging TFT2232Rca and an accumulated-charge-averaging TFT3132Rba (not shown) and a data bus line LdR2. Similarly, a wiring pattern LP is formed in a crossing portion between a connecting wiring of the accumulated-charge-averaging TFT1222Rca and an accumulated-charge-averaging TFT2122Rba (not shown) and the data bus line LdR2.

Next, a resist is subjected to patterning so as to cover the channel region of the pixel TFT22Ra, TFT22Rb, TFT22Rc and TFT22Rd and the TFT region of the accumulated-charge-averaging TFT1222Rca, TFT1222Rdb, TFT2232Rca and TFT2232Rdb, and n-type impurities are doped while having the resist layer acting as a mask. Next, a resist layer is subjected to patterning so as to cover the TFT region of the pixel TFT22Ra, TFT22Rb, TFT22Rc and TFT22Rd, and p-type impurities are doped while having the resist layer acting and the gate bus line Lgi acting as a mask. After resist separation, irradiation with laser beams is executed, thereby activating the impurities.

Next, an interlayer insulating film made of an SiN film is formed by the plasma CVD process. Next, the interlayer insulating layer on the source and drain region is opened, thereby forming a contact hole H. Simultaneously, a part of the interlayer insulating film on the wiring pattern LP is opened, thereby forming a contact hole HL.

Next, source and drain electrode-forming material is subjected to film formation on the interlayer insulating film and patterning, thereby forming a data bus line LdR2 to be connected to a drain region of each of the pixel TFT22Ra, TFT22Rb, TFT22Rc and TFT22Rd via the contact hole H and simultaneously forming a source electrode to be connected to a source region via the contact hole H.

Also, at the same time, source electrodes to be connected to source regions of the accumulated-charge-averaging TFT1222Rca and TFT2232Rca via the contact hole H are formed. At the same time, a wiring to be connected to drain regions of the accumulated-charge-averaging TFT1222Rca and TFT2232Rca is formed, and the wiring is connected to the wiring pattern LP via the contact hole HL. In this way, since the wiring pattern LP is formed in a lower layer than the data bus line LdR2 via an insulating film, it is possible to prevent a short circuit of the both wirings in the crossing portion from occurring.

Also, at the same time, source electrodes to be connected to source regions of the accumulated-charge-averaging TFT1222Rdb and TFT2232Rdb are formed. At the same time, a connecting wiring to be connected to drain regions of the accumulated-charge-averaging TFT1222Rdb and TFT2232Rdb is formed.

Next, a second interlayer insulating film made of an SiN film is formed by the plasma CVD process. Next, the second interlayer insulating film of each of source electrode regions of TFT is opened, thereby forming a contact hole. Next, a transparent electrode material (for example ITO (indium-tin-oxide)) is subjected to film formation and patterning over the entire surface, thereby forming a pixel electrode in each of the sub-pixels S22Ra, S22Rb, S22Rc and S22Rd.

An array substrate for an active matrix type display device having pixel TFTs and accumulated-charge-averaging TFTs formed therein as illustrated in FIG. 9 is thus completed through the foregoing steps.

Since the TFT formed using the CW lateral crystallization technology has a high mobility comparable to single crystalline Si, even when the TFT size is made small, it is possible to secure sufficient driving ability. For that reason, as illustrated in FIG. 9, even when in addition to the pixel TFT22Rc and TFT22Rd, the accumulated-charge-averaging TFT2223Rca and TFT2223Rdb are formed within the pixel, they can be integrated within the region width X substantially equal to that of the conventional TFT. Thus, it is possible to polycrystallize TFT without imparting any change to the optical system for guiding light from CW solid laser.

As described above, according to the example, it is possible to realize smoothing of the pixel display by utilizing a storage function of LCD itself without using an external frame memory. Further, it is also possible to manufacture the LCD of the examples using a conventional manufacturing unit.

According to the invention, it is possible to execute averaging processing of a pixel voltage among pixels without using a frame memory.

What is claimed is:

1. A driving method of a liquid crystal display device, comprising the steps of:
applying a predetermined gray-scale voltage to each of a plurality of sub-pixels constructing a pixel; and
averaging accumulated charge among the adjacent sub-pixels of the adjacent pixels.

2. The driving method of a liquid crystal display device according to claim 1, wherein the averaging step is carried out after charging the plurality of sub-pixels in the same pixel to the same accumulated potential.

3. The driving method of a liquid crystal display device according to claim 1, wherein the pixel and the adjacent pixel are the same color of any one of red (R), green (G) and blue (B).

4. A liquid crystal display device comprising:
a plurality of sub-pixels constructing a pixel; and
an accumulated-charge-averaging TFT which executes averaging of accumulated charge among the adjacent sub-pixels of the adjacent pixels.

5. The liquid crystal display device according to claim 4, further containing:
a pixel TFT for applying a gray-scale voltage to the sub-pixels; and
a gate bus line to which a gate electrode of the accumulated-charge-averaging TFT and a gate electrode of the pixel TFT are commonly connected.

6. The liquid crystal display device according to claim 4, further containing:
a pixel TFT for applying a gray-scale voltage to the sub-pixels;
a gate bus line for pixel TFT to which a gate electrode of the pixel TFT is connected; and
a gate bus line for accumulated-charge-averaging TFT to which a gate electrode of the accumulated-charge-averaging TFT is connected.

7. The liquid crystal display device according to claim 5, wherein the pixel TFT and the accumulated-charge-averaging TFT are different from each other in the conductive type of channel.

8. The liquid crystal display device according to claim 4, wherein the accumulated-charge-averaging TFT connects adjacent sub-pixels having the same color of any one of red (R), green (G) and blue (B) to each other.

9. The liquid crystal display device according to claim 4, wherein at least one of the pixel TFT or the accumulated-charge-averaging TFT has a channel region formed by the CW lateral crystallization technology.
